(19) United States
(12) Patent Application Publication
(10) Pub. No.: US 2008/0043206 A1
(43) Pub. Date: Feb. 21, 2008

(54) LIGHT SOURCE SYSTEM

(75) Inventors: Ching-Wen Chou, Taoyuan Hsien (TW); Mang Ou-Yan, Taoyuan Hsien (TW); Hsin-Hung Lee, Taoyuan Hsien (TW); Yung-Lin Chen, Taoyuan Hsien (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan Hsien (TW)

(21) Appl. No.: 11/756,746

(22) Filed: Jun. 1, 2007

(30) Foreign Application Priority Data
Aug. 18, 2006 (TW) 095130456

(51) Int. Cl. G03B 21/28; G03B 21/26

(52) U.S. Cl. 353/81; 353/94

(57) ABSTRACT

A light source system comprises a first light source device, a second light source device, a first light guiding device, a second light guiding device, and a third light guiding device. The first light source device has a first principal axis. The second light source device has a second principal axis substantially parallel to the first principal axis. The first light guiding device is disposed on the first principal axis for guiding incident light to a first output. The second light guiding device is disposed on the second principal axis for guiding incident light to a second output. The third light guiding device is disposed between the first and second principal axes for guiding part of the incident light of the first and second light source devices to the first and second outputs through the light source devices.

This application claims priority to Taiwan Patent Application No. 095130456 filed on 18 Aug. 2006, the disclosures of which are incorporated herein by reference in its entirety.

### CROSS-REFERENCES TO RELATED APPLICATIONS

Not applicable.

### BACKGROUND OF THE INVENTION

1. Field of the Invention

The present invention relates to a light source system. More particularly, the present invention relates to a light source system of a projecting apparatus with two light sources.

2. Descriptions of the Related Art

Projectors have become popular video equipments in office, family, and conference rooms. The projector is equipped with an internal light source system for illumination. Conventional projectors are equipped with a single light source system. However, due to the physical size limitation, the single light source limits the illuminating ability needed for providing a high brightness and projecting over a large area. To meet the steadily increasing illuminating requirements, the industry has developed two systems: a projector with twin light sources system or a multi-light sources system. FIG. 1A to FIG. 1D show four conventional light source systems. The internal light generated by the light source system goes into a light valve before being applied by the projector. The light valve is just like the gateway of the processing image signal. Thus, shape, incidence angle, intensity, and uniformity of the light should all be processed to meet the requirements for entering into the light valve.

The light source system shown in FIG. 1A generates a semicircle light, which results in a loss of light and a low illumination output efficiency. The light source system shown in FIG. 1B applies many specially made optical devices with complex shapes, increasing the loss in light path and cost. The light source system shown in FIG. 1C also applies many optical devices, also increasing the loss in light path and size limitation. The light source system shown in FIG. 1D applies particularly to elliptic reflectors, which increase the cost and space of the light path, and limits the internal design of the projector.

Therefore, providing a light source system that has a low cost, symmetrical and uniform light distribution and high intensity, while using a plurality of light sources, is desired in the industry.

### SUMMARY OF THE INVENTION

The principal objective of this invention is to provide a light source system. The light source system comprises a first light source apparatus, a second light source apparatus, a first light-guiding apparatus, a second light-guiding apparatus, and a third light-guiding apparatus. The first light source apparatus comprises a first principal optic axis. The second light source apparatus comprises a second principal optic axis parallel to and identical in direction to the first principal optic axis. The first light-guiding apparatus is disposed on the first principal optic axis for guiding the incident light emitting from the first light source apparatus to the first light output end. The second light-guiding apparatus is disposed on the second principal optic axis for guiding the emitted incident light from the second light source apparatus to the second light output end. The third light-guiding apparatus is disposed between the first and the second principal optic axes for guiding a portion of the light emitted from either the first or second light source apparatuses towards either the first or second light output ends.

Another objective of this invention is to provide a light source system with a third light-guiding apparatus. The third light-guiding apparatus is disposed between the first and the second principal optic axes for guiding a portion of the light emitted from either the first or second light source apparatuses towards either the first or second light output ends.

With the aforementioned structures, the present invention provides a small light source system that uses fewer devices and two parallel light sources. The present invention, thus, provides an efficient light source system with a low cost, symmetrical and uniform light distribution, and high intensity.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A to FIG. 1D are conventional light source systems;

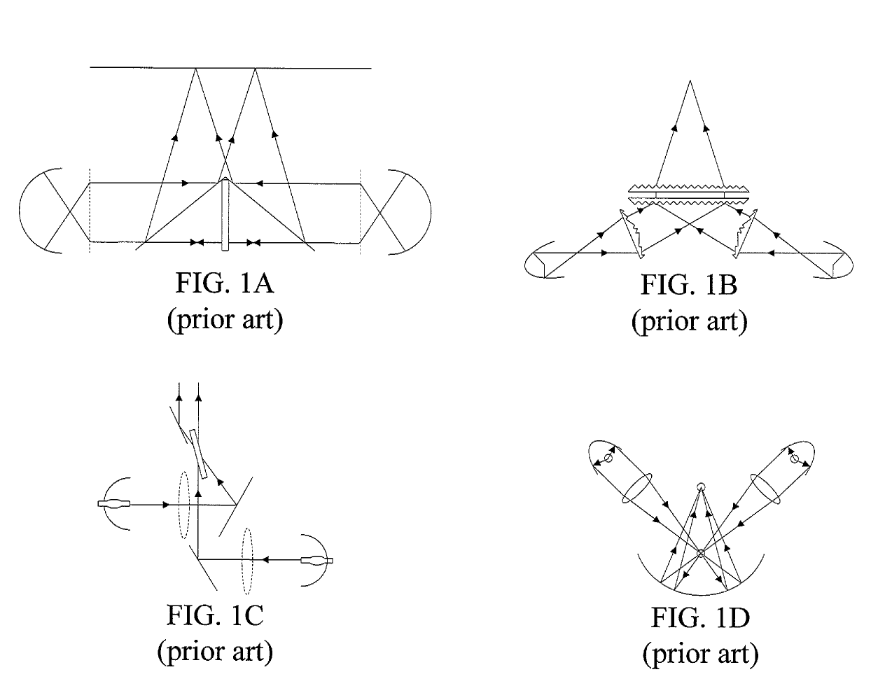

FIG. 2 is the first embodiment of the present invention;

FIG. 3 is the second embodiment of the present invention; and

FIG. 4 is the third embodiment of the present invention.

### DESCRIPTION OF THE PREFERRED EMBODIMENT

Because light disperses divergently, many objective factors may affect its light path. This is well understood by people skilled in this field. Conventionally, light paths are denoted as arrows and lines in the following paragraphs and drawings.

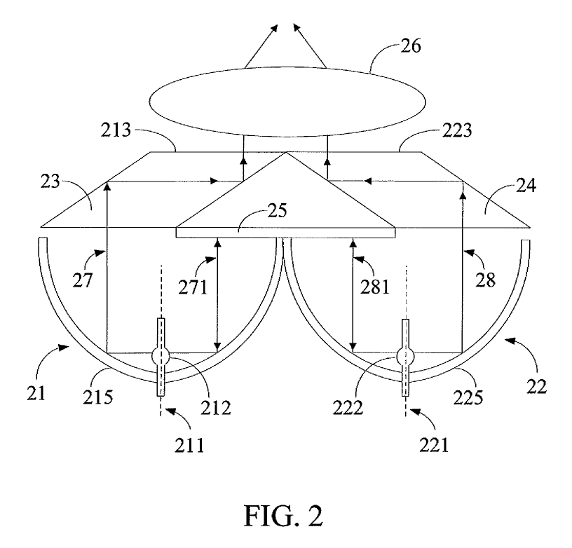

FIG. 2 shows a first preferred embodiment of the present invention, which is a light source system with two light sources. The invention comprises a first light source apparatus 21, a second light source apparatus 22, a first light-guiding apparatus 23, a second light-guiding apparatus 24, a third light-guiding apparatus 25, and a light-focusing apparatus 26. Both the first light source apparatus 21 and the second light source apparatus 22 are equipped with a paraboloid reflector, making their principal axes 211 and 221 parallel. The main light projected from each light source goes along its principal axis. Light centers 212 and 222 of first light source apparatus 21 and light source apparatus 22 are respectively disposed on the foci of the two paraboloid reflectors. The light center is where light is generated. The two paraboloid reflectors are respectively disposed on the principal axes 211 and 221. For example, in the first light source apparatus 21, the emitted light 27 goes into the first light input end of the first light-guiding apparatus 23. In the embodiment, the first light-guiding apparatus 23 is a prism. By designing the incidence angle and emergency angle with a predetermined light path, the light emitting from the first light source apparatus 21 can be totally reflected twice in the prism. The light can then emit from the first light output end 213 of the first light-guiding apparatus 23.

The second light-guiding apparatus 24 is also a prism in the embodiment and disposed symmetrically with the first light-guiding apparatus 23. According to the aforementioned I principle, light 28 emitting from the second light source apparatus 22 goes into the second light-guiding apparatus 24. The light 28 is totally reflected twice after going into the second light input end of the second light-guiding apparatus 24 and then emits from the second light output end 223 of the second light-guiding apparatus 24.

A preferred design of the third light-guiding apparatus 25 includes a planar reflector disposed between the two principal axes 211 and 221. For instance, the first light source apparatus 21 generates light 271 so that the light 271 reaching the third light-guiding apparatus 25 is reflected back to the paraboloid reflector 215 of the first light source apparatus 21. The light 271 then goes through the focus of the paraboloid reflector 215, into the first light input end of the first light-guiding apparatus 23 along with the light 27, along with the aforementioned light path, and then emits from the first light output end 213 of the first light-guiding apparatus 23. By the same way, light 281 generated by the second light source apparatus 22 reaches the third light-guiding apparatus 25. The light 281 is then reflected back to the paraboloid reflector 225 of the second light source apparatus 22, and emits from the second light output end 223 of the second light-guiding apparatus 24.

By summing the lights together (light 271 with light 27 and light 281 with light 28), the light system acquires two parallel light outputs with high brightness. By placing a light-focusing apparatus 26 adjacent to the first light output end 213 and the second light output end 223 apart, the two parallel light outputs can be focused for entering a light valve. The light-focusing apparatus 26 can be a lens.

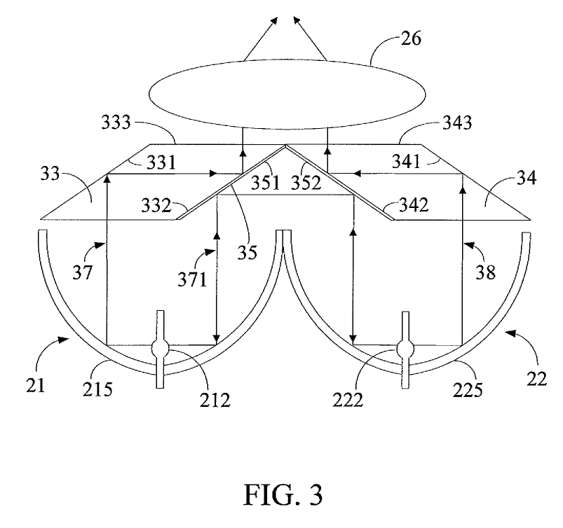

FIG. 3 shows a second embodiment of the present invention, which is similar to the first preferred embodiment. The difference between the first and the second embodiments is that the first light-guiding apparatus 33 and second light-guiding apparatus 34 are cavities with a plurality of internal reflectors. In addition, the third light-guiding apparatus 35 comprises two planar external reflectors. The first light-guiding apparatus 33, the second light-guiding apparatus 34, and the third light-guiding apparatus 35 are disposed together to constitute two single-plane reflectors 331 and 341, and two twin-plane reflectors 332, 351, and 342, 352. The two single-plane reflectors 331 and 341 are disposed symmetrically in view of the two twin-plane reflectors 332, 351, and 342, 352, whereas the two twin-plane reflectors 332, 351, and 342, 352 are disposed between the two single-plane reflectors 331 and 341 and disposed symmetrically in view of each other. In the first light source apparatus 21, light 37 enters the first light-guiding apparatus 33 via the first light input end. The light 37 is sequentially reflected by the internal reflector 331 and 332, and then emits from a first light output end 333 of the first light-guiding apparatus 33. Light 371 generated by the first light source apparatus 21 reaches the third light-guiding apparatus 35. The light 371 is reflected by the external reflector 351 and 352, then enters the paraboloid reflector 225 of the second light source apparatus 22. The light 371 then goes through the optic focus, i.e. the light center 222 of the second light source apparatus 22, and enters the second light-guiding apparatus 34 via the second light input end. Finally, the light 371 emits from the second light output end 343 of the second light-guiding apparatus 34. By the same principle, a portion of the light 38 from the second light source apparatus 22 goes through the second light-guiding apparatus 34 and emits from the second light output end 343. The other portion of the light 38 goes through the third light-guiding apparatus 35, enters the first light source apparatus 21, goes through the first light-guiding apparatus 33, and then emits from the first light output end 333.

The light-focusing apparatus 26 can also be placed adjacent to the first and second light output ends for focusing the light from the first and second light output ends.

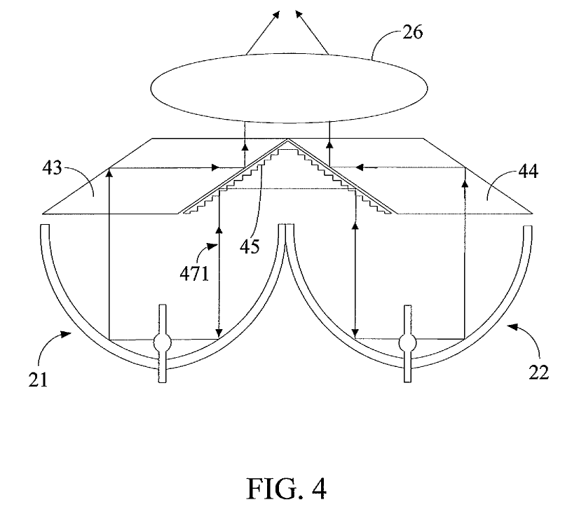

FIG. 4 shows a third embodiment of the present invention. The difference between the second embodiment and the third embodiment is that a third light-guiding apparatus 45 comprises two groups of micro prisms. The micro prisms are symmetrically disposed between the principal axes of the first light source apparatus 21 and the second light source apparatus 22. In the first light source apparatus 21, the two groups of micro prisms are designed for totally reflecting the incident light 471 from the first light source apparatus 21 to the second light source apparatus 22. Then, the light 471 goes substantially along the same light path described in the second embodiment. More particularly, a portion of the light from the first light source apparatus 21 sequentially travels into one of the groups of the micro prisms of the third light-guiding apparatus 45, the other group of the micro prisms, and then the second light source apparatus 22. Likewise, a portion of the light from the second light source apparatus 22 travels into the first light source apparatus 21 via the third light-guiding apparatus 45 similarly.

In the third embodiment, both the first light-guiding apparatus 43 and the second light-guiding apparatus 44 can either be a prism or a cavity with a plurality of reflectors as described in the first and the second embodiments.

In the aforementioned embodiments, people skilled in this field would understand that different devices disposed in corresponding positions can be replaced by each other and will not affect the function of the present invention. For example, though the third light-guiding apparatus 25 shown in FIG. 2 is a planar reflector, this planar reflector can be replaced by a third light-guiding apparatus 35 as described in the second embodiment. The third light-guiding apparatus 35 has two external reflectors 351 and 352. The third light-guiding apparatus 25 can also be replaced by a prism (not shown in the figures) for totally reflecting the incident light from the first light source apparatus 21 to the second light source apparatus 22. The light can then be emitted from the first and the second light output end 213, 223.

The first light-guiding apparatus 23, a prism as described in the first embodiment, can also be replaced by a cavity with a plurality of internal reflectors, such as the planar reflectors 331 and 332 described in the second embodiment. The cavity can even comprise only two opposing planar reflectors for reflecting incident light.

To achieve the preferred efficiency, the incident light entering the first and the second light-guiding apparatuses should be totally reflected. However, this is not a limitation of the present invention. The parallel first light source apparatus 21 and second light source apparatus 22 with paraboloid reflectors are adjacent for generating a substantial circle of light through the light output ends, wherein each light source apparatus provides a semicircle light. However, the illustrated arrangement of light source apparatuses is not the only way, as the light source apparatuses could be arranged to be separated and outputs two half-circles of light.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light source system comprising:
a first light source apparatus adapted to generate a light traveling along a first principal optic axis;
a second light source apparatus adapted to generate a light traveling along a second principal optic axis in which the light of the first light source apparatus and that of the second light source apparatus are substantially parallel to each other and travel in a same direction;
a first light-guiding apparatus being disposed on the first principal optic axis for guiding incident light emitting from the first light source apparatus to a first light output end;
a second light-guiding apparatus being disposed on the second principal optic axis for guiding incident light emitting from the second light source apparatus to a second light output end; and
a third light-guiding apparatus being disposed between the first and the second principal optic axes for guiding a portion of the light emitting from any of the first and the second light source apparatuses toward any of the first and the second light output ends, through one of the same first and the second light source apparatuses.

2. The system as claimed in claim 1, further comprising a light-focusing apparatus being disposed adjacently to the first and the second light output ends for focusing the lights [I from the first and the second light output ends.

3. The system as claimed in claim 2, wherein the light-focusing apparatus is a lens.

4. The system as claimed in claim 1, wherein the first light source apparatus comprising a first light center and a first reflector; the second light source apparatus comprising a second light center and a second reflector; the first principal optic axis and the second principal optic axis hypothetically extend through the first light center and the second light center, respectively.

5. The system as claimed in claim 4, wherein the first reflector is a first paraboloid reflector, and the first light center is a first optic focus of the first paraboloid reflector; the second reflector is a second paraboloid reflector, and the second light center is a second optic focus of the second paraboloid reflector.

6. The system as claimed in claim 1, wherein the first light-guiding apparatus further comprises a first light input end and a plurality of first internal reflectors for guiding a portion of the light from the first light source apparatus to the first light output end through the first light input end and then the plurality of first internal reflectors; the second light-guiding apparatus further comprises a second light input end and a plurality of second internal reflectors for guiding a portion of the light from the second light source apparatus to the second light output end through the second light input end and then the plurality of second internal reflectors.

7. The system as claimed in claim 6, wherein the third light-guiding apparatus is a planar reflector, whereby a portion of the light emitting from the first light source apparatus is reflected back to the first light source apparatus by the planar reflector and then travels into the first light input end, and a portion of the light emitting from the second light source apparatus is reflected back to the second light source apparatus by the planar reflector and then travels into the second light input end.

8. The system as claimed in claim 7, wherein the first light-guiding apparatus and the second light-guiding apparatus has two prisms disposed symmetrically.

9. A light source system comprising:
a first light source apparatus adapted to generate a light traveling along a first principal optic axis;
a second light source apparatus adapted to generate a light traveling along a second principal optic axis in which the light of the first light source apparatus and that of the second light source apparatus are substantially parallel to each other and travel in a same direction;
a first light-guiding apparatus being disposed on the first principal optic axis for guiding incident light emitting from the first light source apparatus to a first light output end;
a second light-guiding apparatus being disposed on the second principal optic axis for guiding incident light emitting from the second light source apparatus to a second light output end; and
a third light-guiding apparatus being disposed between the first and the second principal optic axes for guiding a portion of the light emitting from any of the first and the second light source apparatuses toward any of the first and the second light output ends, through the other of the first and the second light source apparatuses.

10. The system as claimed in claim 9, further comprising a light-focusing apparatus being disposed adjacently to the first and the second light output ends for focusing the lights from the first and the second light output ends.

11. The system as claimed in claim 10, wherein the light-focusing apparatus is a lens.

12. The system as claimed in claim 9, wherein the first light source apparatus comprising a first light center and a first reflector; the second light source apparatus comprising a second light center and a second reflector; the first principal optic axis and the second principal optic axis hypothetically extend through the first light center and the second light center, respectively.

13. The system as claimed in claim 12, wherein the first reflector is a first paraboloid reflector, and the first light center is a first optic focus of the first paraboloid reflector; the second reflector is a second paraboloid reflector, and the second light center is a second optic focus of the second paraboloid reflector.

14. The system as claimed in claim 9, wherein the third light-guiding apparatus comprises a first external reflector and a second external reflector; a portion of the light from the first light source apparatus travels into the second light input end sequentially through the first external reflector, the second external reflector, and the second light source apparatus; a portion of the light from the second light source apparatus travels into the first light input end sequentially through the second external reflector, the first external reflector, and the first light source apparatus.

15. The system as claimed in claim 14, wherein each of the first and the second external reflectors is a planar reflector.

16. The system as claimed in claim 14, wherein each of the first and the second external reflectors is a non-planar reflector.

17. The system as claimed in claim 14, wherein the first light-guiding apparatus, the second light-guiding apparatus, and the third light-guiding apparatus comprise two single-plane reflectors two twin-plane reflectors, in which the two single reflectors are disposed symmetrically in view of the two twin-plane reflectors, whereas the two twin-planes reflectors are disposed between the two single reflectors and disposed symmetrically in view of each other.

18. The system as claimed in claim 16, wherein each of the first and the second external reflectors comprises two groups of micro prisms.
